(19) United States
(12) Patent Application Publication
(10) Pub. No.: US 2009/0226720 A1
(43) Pub. Date: Sep. 10, 2009

(54) VARNISH FOR PARTIAL DISCHARGE RESISTANT ENAMELED WIRE AND PARTIAL DISCHARGE RESISTANT ENAMELED WIRE

(75) Inventors: Hideyuki KIKUCHI, Hitachi (JP); Yuji TAKANO, Mito (JP); Yuki HONDA, Hitachi (JP)

Correspondence Address: SCULLY SCOTT MURPHY & PRESSER, PC, 400 GARDEN CITY PLAZA, SUITE 300, GARDEN CITY, NY, 11530, US

(73) Assignees: HITACHI MAGNET WIRE CORP., Ibaraki (JP); HITACHI CABLE, LTD., Tokyo (JP)

(21) Appl. No.: 12/397,853

(22) Filed: Mar. 4, 2009

(30) Foreign Application Priority Data
Mar. 6, 2008 (JP) 2008-056078

(51) Int. Cl. C09D 199/00; B32B 5/02

(52) U.S. Cl. 428/372; 106/222

(57) ABSTRACT

A varnish for a partial discharge resistant enameled wire includes an insulating varnish, and an organosol including an inorganic fine particle comprising a metal oxide fine particle or a silicon oxide fine particle. The organosol is dispersed in the insulating varnish. The inorganic fine particle includes a hollow portion therein.

The present application is based on Japanese patent application No.2008-56078 filed Mar. 6, 2008, the entire contents of which are incorporated herein by reference.

### BACKGROUND OF THE INVENTION

1. Field of the Invention

This invention relates to a varnish for partial discharge resistant enameled wire and a partial discharge resistant enameled wire.

2. Description of the Related Art

The partial discharge is a weak discharge which occurs in case that there are minute gaps inside of an insulator such as a wire or a cable, or between the insulators, so that an electric field concentrates at the minute gaps. If the partial discharge occurs, the insulator deteriorates so as to result in an insulation breakdown.

In a winding wire mainly used for coils of a motor or a transformer, particularly, in an enameled wire with an insulating film formed by coating and baking a resin varnish on a conductor, the partial discharge mainly occurs between the wires (between film and film) or between the wire and the earth (between film and core), and occurs between the molecular chains of the resin film due to collision of charged particles or between the wire and the earth (between film and core), and an erosion of the film is promoted mainly due to the breakage, heat-generation and the like of the molecular chains of the resin film due to collision of charged particles so as to result in the insulation breakdown.

Recent years, in a system for driving a motor controlled by an inverter used for an energy-saving and a variable speed, such a case that an inverter surge (precipitous overvoltage) occurs and it causes the insulation breakdown is increased. It has been already found that the overvoltage due to the inverter surge causes the partial discharge so as to result in the insulation breakdown. In order to improve the voltage application life of the enameled wire used for coils of a motor or a transformer, a method for preventing the erosion of the film caused by the partial discharge is proposed, the method including the step of forming an insulating film by using a resin varnish containing an inorganic material.

For example, an enameled wire is known, which has an insulating film formed by using a resin varnish obtained by dispersing inorganic insulating particles such as silica, titania in a heat resistant resin liquid dissolved in an organic solvent. The inorganic insulating particle provides a partial discharge resistance to the enameled wire, and further, contributes to improvement of a thermal conductivity and a strength, and reduction of a heat expansion.

As methods of dispersing silica fine particles of the inorganic insulating particles, some methods are known, the methods including a method of adding and dispersing powder of silica particle to (in) a resin solution and a method of mixing a resin solution and an organosilica sol (for example, disclosed by JP-B-3496636 and JP-A-2004-204187). In case of using the organosilica sol, a varnish is obtained, which is easily mixed, and in which silica is highly dispersed, in comparison with the case of adding the powder of silica particle, and further, an enameled wire is obtained, which has good properties such as flexibility, bendability, windability, and tensibility. However, in this case, the organosilica sol is required to have good compatibility with the resin solution.

Further, for example, inorganic insulating particles are known, which include a fine powder having void part, and a hollow inorganic particle sol having a particle diameter of about several tens of nm and uniformly dispersed in a dispersion medium (for example, disclosed by JP-B-3761189, JP-A-2004-203683 and JP-A-2001-233611).

Furthermore, a method of directly preventing the occurrence of the partial discharge is known, the method being capable of reducing an electrical field between the wires (electrical field applied to air layer existing between the wires) by decreasing permittivity of the insulating film.

In an organic/inorganic hybrid material, if permittivity of the inorganic material can be reduced, permittivity of the insulating film can be also reduced. However, the inorganic material generally has higher permittivity than the organic material so that lowering of permittivity is difficult.

Further, the lowering of permittivity is dependent on the resin structure of the organic insulating material, so that harmful effect on heat resistance, mechanical properties and the like may be provided, and it is extremely difficult to realize the lowering of permittivity, while keeping excellent various properties which the enameled wire has.

### SUMMARY OF THE INVENTION

Therefore, it is an object of the invention to provide a vanish for partial discharge resistant enameled wire being capable of realizing a partial discharge resistant enameled wire which simultaneously achieves an improvement in a partial discharge inception voltage by lowering permittivity, and a partial discharge erosion inhibitory effect by containing an inorganic material, and has an excellent property of voltage application life, by means of using a varnish for partial discharge resistant enameled wire in which an organosol of inorganic fine particles having void part (hollow or porous part) interiorly is uniformly colloidally-dispersed, so as to form a film. And it is another object of the invention to provide the above-mentioned partial discharge resistant enameled wire.
(1) According to one embodiment of the invention, a varnish for partial discharge resistant enameled wire comprises:

an insulating varnish; and

an organosol including an inorganic fine particle comprising a metal oxide fine particle or a silicon oxide fine particle, the organosol being dispersed in the insulating varnish,

wherein the inorganic fine particle comprises a hollow portion therein.

In the above embodiment (1), the following modifications and changes can be made.

(i) The hollow portion occupies a space of not less than 10% of a whole volume of the inorganic fine particle.

(ii) The inorganic fine particle is contained 1 to 100 parts by weight relative to 100 parts by weight of a resin portion of the insulating varnish.

(iii) The inorganic fine particle has an average particle diameter of not more than 100 nm.

(iv) The organosol is uniformly dispersed in a dispersion medium compatible with the insulating varnish, and is in the form of a transparent or opalescent colloid.
(2) According to another embodiment of the invention, a partial discharge resistant enameled wire comprises:

a conductor; and

a partial discharge resistant enamel film obtained by coating and baking the varnish according to the above embodiment (1) on the conductor.

In the above embodiment (2), the following modifications and changes can be made.

(v) The partial discharge resistant enamel film is formed directly or via an other insulating film on the conductor.

### ADVANTAGES OF THE INVENTION

According to the invention, a varnish for partial discharge resistant enameled wire has excellent uniform dispersibility and transparency by application of sol-like silica (one example), and when the varnish for partial discharge resistant enameled wire according to the invention is coated and baked on a conductor, it has excellent partial discharge resistance. Further, by setting a dispersion amount of a hollow or porous organosilica sol (one example) in the varnish for partial discharge resistant enameled wire to a desired range, an partial discharge resistant enameled wire can be obtained, which has excellent elongation property, partial discharge resistance and partial discharge inception voltage while keeping general various properties which the enameled wire has such as appearance, flexibility, breakdown voltage in good state. Furthermore, by using a silica sol containing hollow or porous silica particles, the lowering of permittivity in the organic/inorganic hybrid material can be realized and the partial discharge inception voltage is improved so that the enameled wire can be obtained, which is further improved in the partial discharge resistance.

### BRIEF DESCRIPTION OF THE DRAWINGS

The preferred embodiments according to the invention will be explained below referring to the drawings, wherein:

FIG. 1 is a cross-sectional view schematically showing a partial discharge resistant enameled wire in one embodiment to which a varnish for partial discharge resistant enameled wire according to the invention is applied;

FIG. 2 is a cross-sectional view schematically showing a partial discharge resistant enameled wire in another embodiment to which a varnish for partial discharge resistant enameled wire according to the invention is applied; and

FIG. 3 is a cross-sectional view schematically showing a partial discharge resistant enameled wire in another embodiment to which a varnish for partial discharge resistant enameled wire according to the invention is applied.

### DETAILED DESCRIPTION OF THE PREFERRED EMBODIMENTS

The preferred embodiments according to the invention will be explained below referring to the drawings.

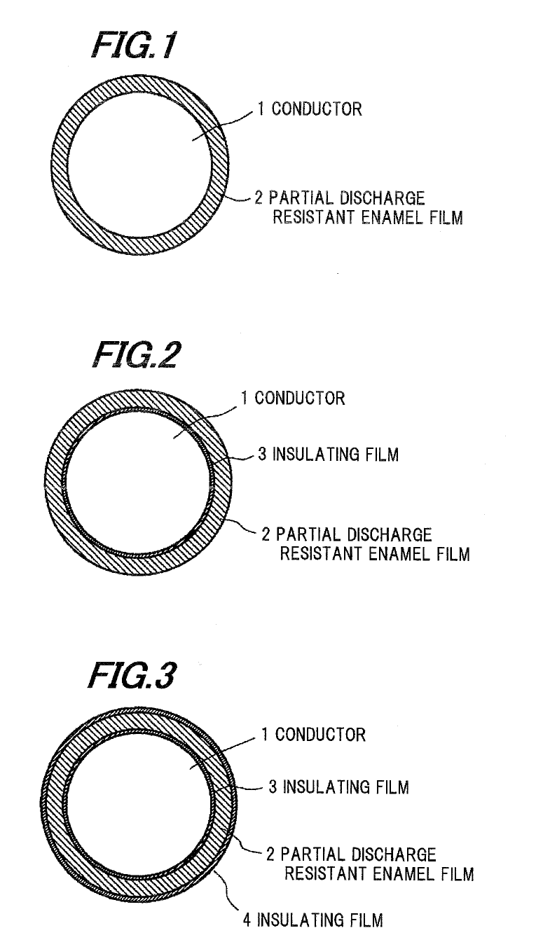

FIGS. 1 to 3 are cross-sectional views schematically showing partial discharge resistant enameled wires to which a varnish for partial discharge resistant enameled wire according the invention is applied.

FIG. 1 shows a partial discharge resistant enameled wire which is obtained by coating and baking a varnish for partial discharge resistant enameled wire according to the invention on a conductor 1 directly, so as to form a partial discharge resistant enamel film 2.

FIG. 2 shows a partial discharge resistant enameled wire which is obtained by forming an other insulating film 3 on the periphery of the conductor 1, and coating and baking the varnish for partial discharge resistant enameled wire according to the invention on the other insulating film 3, so as to form the partial discharge resistant enamel film 2.

FIG. 3 shows a partial discharge resistant enameled wire which is obtained by forming the other insulating film 3 on the periphery of the conductor 1, and coating and baking the varnish for partial discharge resistant enameled wire according to the invention on the other insulating film 3 so as to form the partial discharge resistant enamel film 2, and further forming an other insulating film 4 thereon.

The insulating films 3, 4 are not limited in material unless they harm the partial discharge resistance and general properties, and with regard to the material the insulating film 3 directly formed on the conductor 1 can be different from the insulating film 4 as the top layer.

Although not shown in the drawings, an enameled wire can be also used, which is obtained by forming the partial discharge resistant enamel film 2 on the conductor 1 shown in FIG. 1 directly and forming the other insulating film 3 on the enamel film 2.

Next, a varnish for partial discharge resistant enameled wire according to the invention which is capable of forming the partial discharge resistant enamel film 2 will be explained below.

A varnish for partial discharge resistant enameled wire according to the invention includes a varnish for enameled wire and at least one selected from organosol containing an inorganic fine particle dispersed in the varnish for enameled wire, wherein the inorganic fine particle has void part (hollow or porous part) interiorly, and at least one of the inorganic fine particles having void part (hollow or porous part) interiorly is contained in the proportion of 1 to 100 weight parts (or parts by weight) relative to 100 weight parts (or parts by weight) of the resin portion of the varnish for enameled wire.

Further, a partial discharge resistant enameled wire according to the invention is obtained by coating and baking the above-mentioned varnish for partial discharge resistant enameled wire on a conductor directly or via another insulating film. An enameled wire can be also used, which is obtained by further forming an organic insulating layer on the enameled wire described above.

According to the invention, the dispersion amount of the hollow or porous inorganic fine particle is usually 1 to 100 weight parts (mass parts) to 100 weight parts (mass parts) of the resin portion of the varnish for enameled wire, and it is preferable to be 5 to 50 weight parts (mass parts). If less than 1 weight part, both the effects of improving partial discharge resistance and lowering permittivity are not provided adequately, and if more than 120 weight parts, flexibility and elongation property are reduced.

The partial discharge resistant enameled wire according to the invention is obtained by forming a transparent or opalescent colloid (sol) by dispersing a hollow or porous inorganic fine particle in a dispersion medium excellent in compatibility with a varnish for enameled wire and dispersing the obtained colloid (sol) in the varnish for enameled wire.

In this case, it is preferable to use the hollow or porous inorganic fine particle having an average particle diameter of not more than 100 nm (100×10⁻⁹ m), in terms of obtaining a uniform dispersion state without an occurrence of secondary aggregation, and realizing an enamel coating having good smoothness and flexibility or a varnish for enameled wire having good stability.

Further, the average particle diameter is expressed in a median diameter based on particle distribution obtained from a laser diffraction method and the like.

The hollow or porous inorganic fine particle used in the invention usually has the void part formed by the hollow or porous portion of which volume is not less than 10% to the whole volume of the inorganic fine particle, and 20 to 60% is preferable. If less than 10%, both the effects of improving the partial discharge resistance and lowering permittivity are not provided adequately. The upper limit is not particularly limited, but it is preferable that the volume of the void part is as large as possible, since the larger the volume, the more the effect (the lower the permittivity), however theoretically it results in less than 100% and the shape thereof can not be maintained since the more the volume ratio nears 100%, the less the thickness of shell (outer shell) of the inorganic fine particle, so that it can not help remaining within the range capable of keeping the shape of the hollow or porous inorganic fine particle.

The conductor used in the invention includes copper wire, aluminum wire, silver wire, nickel wire and the like, and has a round shape, a flat shape and the like as a cross-section shape.

The varnish for enameled wire being a base material of the varnish for partial discharge resistant enameled wire according to the invention is not limited in material, if it is industrially used, and includes a varnish for formal enameled wire, a varnish for polyester enameled wire, a varnish for polyester-imide enameled wire, a varnish for polyamide-imide enameled wire, a varnish for polyimide enameled wire and the like.

Other than the above, the following varnish for enameled wire can be used, that is a varnish for enameled wire obtained as a resin varnish by dissolving amorphous engineering plastics in a solvent, the amorphous engineering plastics including polysulfone, polyether sulfone, polyphenyl ether sulfone, polyether imide and the like, or a resin varnish consisting of a silane-modified hybrid material being commercially available (for example, manufactured by Arakawa Chemical Industries, Ltd., sold under a trade name of “Compoceran”).

In the invention, the organosol containing the hollow or porous inorganic fine particle is not particularly limited in material and can be used if it is in a state of sol, has good dispersibility to the varnish for enameled wire, is capable of improving partial discharge resistance, and is capable of lowering permittivity, and the inorganic fine particle is also not particularly limited in material and, includes a metal oxide such as silica, alumina, zirconia, titania, yttria, or a silicon oxide, but it is preferable to use silica in terms of high industrial productivity, low cost and low permittivity.

Further, the dispersion medium is also not particularly limited, but it is preferable to be replaced with a solvent having excellent compatibility with the varnish for enameled wire. Concretely, the dispersion medium includes a mixed solvent between phenols or benzyl alcohol and aromatic alkylbenzene as a main component, and a mixed solvent between xylene or toluene as a main component and lower alcohol, and these dispersion media have good compatibility with a resin varnish for enameled wire using a cresol type solvent, that is a varnish for polyester type enameled wire and the like, and further, dispersion media consisting of N-methyl-2-pyrolidone, dimethylacetamide, dimethylformamide, γ-butyrolactone, cyclohexane or a mixed solvent thereof have good compatibility with a varnish for enameled wire using a N-methyl-2-pyrolidone type solvent as a main component, that is a varnish for polyamide-imide type or polyimide type enameled wire. Further, methanol and methyl ethyl isobutyl ketone are included.

### EXAMPLES

The varnish for partial discharge resistant enameled wire respectively obtained by Examples 1 to 7 and Comparative Examples 1 to 5 described below were coated and baked on a copper conductor having a diameter of 0.8 mm so as to result in obtaining a partial discharge resistant enameled wire having a partial discharge resistant enamel film of 30 nm in film thickness.

### Example 1

A hollow organosilica sol (dispersion medium: benzyl alcohol/naphtha type mixed dispersion medium, average diameter of silica particle: 23 nm, volume ratio of hollow portion: 30%) was dispersed in a varnish for tris-2 (hydroxyethyl isocyanurate) modified polyester-imide enameled wire, in the proportion of 20 weight parts (mass parts) of the silica portion of the hollow organosilica sol to 100 weight parts (mass parts) of the resin portion of the varnish for enameled wire, so as to obtain a varnish for partial discharge resistant polyester-imide enameled wire.

### Example 2

A hollow organosilica sol (dispersion medium: benzyl alcohol/naphtha type mixed dispersion medium, average diameter of silica particle: 45 nm, volume ratio of hollow portion: 35%) was dispersed in a varnish for tris-2 (hydroxyethyl isocyanurate) modified polyester-imide enameled wire, in the proportion of 50 weight parts (mass parts) of the silica portion of the hollow organosilica sol to 100 weight parts (mass parts) of the resin portion of the varnish for enameled wire, so as to obtain a varnish for partial discharge resistant polyester-imide enameled wire.

### Example 3

A hollow organosilica sol (dispersion medium: γ-butyrolactone, average diameter of silica particle: 23 nm, volume ratio of hollow portion: 30%) was dispersed in a varnish for polyamide-imide enameled wire, in the proportion of 20 weight parts (mass parts) of the silica portion of the hollow organosilica sol to 100 weight parts (mass parts) of the resin portion of the varnish for enameled wire, so as to obtain a varnish for partial discharge resistant polyamide-imide enameled wire.

### Example 4

A hollow organotitania sol (dispersion medium: γ-butyrolactone, average diameter of titania particle: 60 nm, volume ratio of hollow portion: 40%) was dispersed in a varnish for polyamide-imide enameled wire, in the proportion of 50 weight parts (mass parts) of the titania portion of the hollow organosilica sol to 100 weight parts (mass parts) of the resin portion of the varnish for enameled wire, so as to obtain a varnish for partial discharge resistant polyamide-imide enameled wire.

### Example 5

A hollow organosilica sol (dispersion medium: γ-butyrolactone, average diameter of silica particle: 23 nm, volume ratio of hollow portion: 30%) was dispersed in a varnish for polyimide enameled wire, in the proportion of 20 weight parts (mass parts) of the silica portion of the hollow organosilica sol to 100 weight parts (mass parts) of the resin portion of the varnish for enameled wire, so as to obtain a varnish for partial discharge resistant polyimide enameled wire.

### Example 6

Next, the varnish for partial discharge resistant enameled wire obtained by Example 1 was coated and baked on a copper conductor having a diameter of 0.8 mm so as to result in obtaining a partial discharge resistant enameled wire having a partial discharge resistant enamel film of 30 nm in film thickness, and then a varnish for lubricative polyamide-imide enameled wire (manufactured by Hitachi Chemical Company, Ltd. sold under a product number of “HI-406 SL”) was coated and baked on the partial discharge resistant enamel film so as to result in obtaining a partial discharge resistant lubricative enameled wire covered with an insulating film of 3 μm in film thickness.

### Example 7

A hollow organosilica sol (dispersion medium: benzyl alcohol/naphtha type mixed dispersion medium, average diameter of silica particle: 23 nm, volume ratio of hollow portion: 30%) was dispersed in a varnish for tris-2 (hydroxyethyl isocyanurate) modified polyester-imide enameled wire, in the proportion of 120 weight parts (mass parts) of the silica portion of the hollow organosilica sol to 100 weight parts (mass parts) of the resin portion of the varnish for enameled wire, so as to obtain a varnish for partial discharge resistant polyester-imide enameled wire.

### Comparative Example 1

A hollow silica powder (average particle diameter of silica: 200 nm, volume ratio of hollow portion: 40%) was dispersed in a varnish for tris-2 (hydroxyethyl isocyanurate) modified polyester-imide enameled wire, in the proportion of 50 weight parts (mass parts) of the silica portion of the hollow silica powder to 100 weight parts (mass parts) of the resin portion of the varnish for enameled wire, so as to obtain a varnish for partial discharge resistant polyester-imide enameled wire.

### Comparative Example 2

An organosilica sol (dispersion medium: benzyl alcohol/naphtha type mixed dispersion medium, average diameter of silica particle: 23 nm) was dispersed in a varnish for tris-2 (hydroxyethyl isocyanurate) modified polyester-imide enameled wire, in the proportion of 20 weight parts (mass parts) of the silica portion of the organosilica sol to 100 weight parts (mass parts) of the resin portion of the varnish for enameled wire, so as to obtain a varnish for partial discharge resistant polyester-imide enameled wire.

### Comparative Example 3

An organosilica sol (dispersion medium: γ-butyrolactone, average diameter of silica particle: 23 nm) was dispersed in a varnish for polyamide-imide enameled wire, in the proportion of 20 weight parts (mass parts) of the silica portion of the organosilica sol to 100 weight parts (mass parts) of the resin portion of the varnish for enameled wire, so as to obtain a varnish for partial discharge resistant polyamide-imide enameled wire.

### Comparative Example 4

A polyester-imide enameled wire (diameter of conductor: 0.8 mm) was obtained by using the varnish for tris-2 (hydroxyethyl isocyanurate) modified polyester-imide enameled wire.

### Comparative Example 5

A polyamide-imide enameled wire (diameter of conductor: 0.8 mm) was obtained by using the varnish for polyamide-imide enameled wire.

Aspects of Examples and Comparative Examples and properties of the enameled wires obtained are shown in Table 1.

TABLE 1

| | | | Ex 1 | Ex 2 | Ex 3 | Ex 4 | Ex 5 | Ex 6 |
|---|---|---|---|---|---|---|---|---|
| Resin | THEIC modified PEI | | 100 | 100 | | | | 100 |
| | PAI | | | | 100 | 100 | | |
| | PI | | | | | | | 100 |
| Inorganic fine | HSS | BA/N, ADSP = 23 nm, VRHP = 30% | 20 | | | | | 20 |
| particle | | BA/N, ADSP = 45 nm, VRHP = 35% | | 50 | | | | |
| | | BL, ADSP = 23 nm, VRHP = 30% | | | 20 | | 20 | |
| | HTS | BL, ADSP = 60 nm, VRHP = 40% | | | | 50 | | |
| | HSP | ADSP = 200 nm, VRHP = 40% | | | | | | |
| | SS | BA/N, ADSP = 23 nm | | | | | | |
| | | BL, ADSP = 23 nm | | | | | | |

| Structure of | Lower layer | | HSS | HSS | HSS | HTS | HSS | HSS |
|---|---|---|---|---|---|---|---|---|
| enameled wire | | | dispersed | dispersed | dispersed | dispersed | dispersed | dispersed |
| | | | THEIC | THEIC | PAI | PAI | PI | THEIC |
| | | | modified | modified | | | | modified |
| | | | PEI | PEI | | | | PEI |
| | Upper layer | | — | — | | — | — | slipping |
| | | | | | | | | PAI |
| Properties of | Dimensions | Diameter of conductor | 0.800 | 0.800 | 0.801 | 0.800 | 0.800 | 0.799 |
| enameled wire | | Film thickness of lower layer | 0.030 | 0.030 | 0.031 | 0.030 | 0.030 | 0.030 |
| | | Film thickness of upper layer | — | — | — | — | — | 0.003 |
| | | Finished diameter | 0.860 | 0.860 | 0.862 | 0.860 | 0.860 | 0.865 |

| Appearance | | clear | clear | clear | clear | clear | clear |
|---|---|---|---|---|---|---|---|
| | | EIW | EIW | AIW | AIW | PIW | EIW |
| | | color | color | color | color | color | color |
| Flexibility: Acceptable wound diameter | | 1d | 1d | 1d | 1d | 1d | 1d |
| Slippage | Static friction coefficient | 0.11 | 0.13 | 0.12 | 0.12 | 0.13 | 0.05 |
| Abrasion | Reciprocating wear test | 35 | 37 | 421 | 433 | 45 | 352 |
| resistance | (number of reciprocation) | | | | | | |

| Breakdown voltage (kV) | | 15.6 | 15.7 | 16.0 | 16.0 | 15.3 | 15.6 |
|---|---|---|---|---|---|---|---|
| Partial discharge inception voltage (V) | | 662.9 | 665.3 | 636.4 | 635.8 | 656.0 | 659.4 |
| V-t characteristic (h) | Normal state | 483.6 | 471.0 | 437.1 | 430.6 | 411.2 | 480.5 |
| 10 kHz-1.2 kV | 20% elongation | 286.9 | 226.7 | 377.6 | 355.0 | 336.5 | 288.9 |
| Sine-wave | | | | | | | |

| | | | | Comp | Comp | Comp | Comp | Comp |
|---|---|---|---|---|---|---|---|---|
| | | | Ex 7 | Ex 1 | Ex 2 | Ex 3 | Ex 4 | Ex 5 |
| Resin | THEIC modified PEI | | 100 | 100 | 100 | | 100 | |
| | PAI | | | | | 100 | | 100 |
| | PI | | | | | | | |
| Inorganic fine | HSS | BA/N, ADSP = 23 nm, VRHP = 30% | 120 | | | | | |
| particle | | BA/N, ADSP = 45 nm, VRHP = 35% | | | | | | |
| | | BL, ADSP = 23 nm, VRHP = 30% | | | | | | |
| | HTS | BL, ADSP = 60 nm, VRHP = 40% | | | | | | |
| | HSP | ADSP = 200 nm, VRHP = 40% | | 50 | | | | |
| | SS | BA/N, ADSP = 23 nm | | | 20 | | | |
| | | BL, ADSP = 23 nm | | | | 20 | | |

| Structure of | Lower layer | | HSS | HSP | SS | SS | THEIC | PAI |
|---|---|---|---|---|---|---|---|---|
| enameled wire | | | dispersed | dispersed | dispersed | dispersed | modified | |
| | | | THEIC | THEIC | THEIC | PAI | PEI | |
| | | | modified | modified | modified | | | |
| | | | PEI | PEI | PEI | | | |
| | Upper layer | | — | — | — | — | — | — |
| Properties of | Dimensions | Diameter of conductor | 0.799 | 0.800 | 0.800 | 0.800 | 0.800 | 0.801 |
| enameled wire | | Film thickness of lower layer | 0.030 | 0.030 | 0.031 | 0.030 | 0.030 | 0.030 |
| | | Film thickness of upper layer | — | — | — | — | — | — |
| | | Finished diameter | 0.859 | 0.860 | 0.863 | 0.860 | 0.860 | 0.861 |

| Appearance | | clear | opaque | clear | clear | clear | clear |
|---|---|---|---|---|---|---|---|
| | | EIW | white | EIW | AIW | EIW | AIW |
| | | color | | color | color | color | color |
| Flexibility: Acceptable wound diameter | | 2d | 3d | 1d | 1d | 1d | 1d |
| Slippage | Static friction coefficient | 0.12 | 0.10 | 0.12 | 0.12 | 0.12 | 0.13 |
| Abrasion | Reciprocating wear test | 31 | 15 | 36 | 444 | 38 | 424 |
| resistance | (number of reciprocation) | | | | | | |

| Breakdown voltage (kV) | | 15.3 | 12.6 | 15.7 | 15.9 | 15.2 | 16.0 |
|---|---|---|---|---|---|---|---|
| Partial discharge inception voltage (V) | | 668.9 | 640.9 | 601.9 | 561.6 | 596.1 | 561.0 |
| V-t characteristic (h) | Normal state | 499.3 | 4.6 | 35.8 | 28.2 | 0.70 | 0.65 |
| 10 kHz-1.2 kV | 20% elongation | 2.1 | 0.80 | 17.8 | 18.2 | 0.65 | 0.58 |
| Sine-wave | | | | | | | |

Notes:
Ex: Example, Comp Ex: Comparative Example,
BA/N: benzyl alcohol/naphtha system mixed dispersion medium,
ADSP: average diameter of silica particle,
VRHP: volume ratio of hollow portion,
BL: γ-butyrolactone system dispersion medium,
THEIC: tris (2-hydroxyethyl isocyanurate)
HSS: hollow silica sol,
HTS: hollow titania sol,
HSP: hollow silica powder,
PEI: polyester-imide,
PAI: polyamide-imide,
PI: polyimide

General property test of enameled wire was carried out according to JIS-C3003.

Partial discharge resistance was evaluated by V-t characteristic test (voltage-partial discharge lifetime characteristic test) to enameled wires in normal state and V-t characteristic test (voltage-partial discharge lifetime characteristic test) to enameled wires elongated by 20%.

Further, in Table 1, “tris (2-hydroxyethyl isocyanurate)” was abbreviated to “THEIC”.

As will be appreciated from Table 1, the partial discharge resistant enameled wires obtained by coating and baking the varnish for enameled wire in which the hollow organosilica sol is dispersed on a conductor (Examples 1 to 7) have a higher partial discharge inception voltage than Comparative Examples and the V-t property in the original state of enameled wire is also extremely excellent.

Further, by using a varnish for enameled wire in which an organosilica sol is dispersed in the proportion of 1 to 100 weight parts (preferably 20 to 50 weight parts) as the silica portion to 100 weight parts of the resin portion of the varnish for enameled wire, an enameled wire can be obtained, which has excellent elongation property and partial discharge resistance and partial discharge inception voltage improved by the lowering of permittivity due to an effect of the hollow particles, while keeping general various properties which the enameled wire has such as appearance, flexibility, breakdown voltage in good state.

The partial discharge resistant enameled wire of Comparative Example 1 which is obtained by directly blending hollow fine particles of silica has extremely poor lifetime of partial discharge resistance and bad flexibility in ordinary state and after being elongated. It is supposed that this is caused by a bad dispersion state due to an occurrence of secondary aggregation.

The partial discharge resistant enameled wires of Comparative Examples 2 to 3 which are obtained by blending the same amount of silica sol of solid (not hollow) particles as Examples 1 and 3 have partial discharge inception voltage lowered by about 60 to 70 V in comparison with Examples 1 and 3, as a result the lifetime of partial discharge resistance thereof is shortened.

The partial discharge resistant enameled wires of Comparative Examples 4 to 5 which do not include inorganic fine particles have low partial discharge inception voltage and further have such an extremely bad lifetime of partial discharge resistance as 0.58 to 0.70 hour.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A varnish for a partial discharge resistant enameled wire, comprising:
an insulating varnish; and
an organosol including an inorganic fine particle comprising a metal oxide fine particle or a silicon oxide fine particle, the organosol being dispersed in the insulating varnish,
wherein the inorganic fine particle comprises a hollow portion therein.

2. The varnish according to claim 1, wherein the hollow portion occupies a space of not less than 10% of a whole volume of the inorganic fine particle.

3. The varnish according to claim 1, wherein the inorganic fine particle is contained 1 to 100 parts by weight relative to 100 parts by weight of a resin portion of the insulating varnish.

4. The varnish according to claim 1, wherein the inorganic fine particle has an average particle diameter of not more than 100 nm.

5. The varnish according to claim 1, wherein the organosol is uniformly dispersed in a dispersion medium compatible with the insulating varnish, and is in the form of a transparent or opalescent colloid.

6. A partial discharge resistant enameled wire, comprising:
a conductor; and
a partial discharge resistant enamel film obtained by coating and baking the varnish according to claim 1 on the conductor.

7. The partial discharge resistant enameled wire according to claim 6, wherein the partial discharge resistant enamel film is formed directly or via an other insulating film on the conductor.
